(19) United States
(12) Patent Application Publication
(10) Pub. No.: US 2025/0236196 A1
(43) Pub. Date: Jul. 24, 2025

(54) POWER MODULE FOR SIMULTANEOUS CHARGING AND DISCHARGING OF ELECTRIC VEHICLE BATTERY SYSTEMS

(71) Applicant: GM Global Technology Operations LLC, Detroit, MI (US)

(72) Inventors: Dhanya Sankaran, Christiansburg, VA (US); Khorshed Mohammed Alam, Canton, MI (US); Minh-Khai Nguyen, Troy, MI (US); Rasoul Hosseini, Troy, MI (US)

(21) Appl. No.: 18/418,842

(22) Filed: Jan. 22, 2024

(51) Int. Cl. B60L 53/62; B60L 53/60; H02J 7/02

(52) U.S. Cl. CPC B60L 53/62; B60L 53/60; H02J 7/02; B60L 2210/10; B60L 2210/30

(57) ABSTRACT

A system for controlling charging and discharging of a battery assembly of a vehicle includes an outlet and a power module including a charging circuit having a bidirectional alternating current (AC)-direct current (DC) converter and a split phase inverter connected to a common transformer. A controller is configured to control the power module according to at least one of a plurality of operating modes including a charging mode in which AC power charges the battery assembly via the charging circuit. The operating modes include a simultaneous charging and discharging mode in which the power module generates a split phase voltage including a first AC voltage and a second AC voltage, the first AC voltage being out of phase with the second AC voltage, where the first AC voltage is applied to charge the battery assembly and the second AC voltage is provided to an external system via the outlet.

### INTRODUCTION

The disclosure relates to electric vehicles. More specifically, the disclosure relates to electric vehicle charging and discharging.

Vehicles, including gasoline and diesel power vehicles, as well as electric and hybrid electric vehicles, feature battery storage for purposes such as powering electric motors, electronics and other vehicle subsystems. Such vehicles typically include various different modules for controlling aspects of charging. For example, some electric and hybrid vehicles include separate modules for power electric motors and low voltage components. Some vehicles also include capability to provide alternating current (AC) power from vehicle battery systems.

### SUMMARY

In one exemplary embodiment, a system for controlling charging and discharging of a battery assembly of a vehicle includes an outlet and a power module configured to be selectively connected to the outlet and the battery assembly, the power module including a charging circuit having a bidirectional alternating current (AC)-direct current (DC) converter and a split phase inverter, the charging circuit and the split phase inverter connected to a common transformer. A controller is configured to control the power module according to at least one of a plurality of operating modes, the plurality of operating modes including a charging mode in which AC power from a power source charges the battery assembly via the charging circuit. The plurality of operating modes include a simultaneous charging and discharging mode in which the power module generates a split phase voltage including a first AC voltage and a second AC voltage, the first AC voltage being out of phase with the second AC voltage, where the first AC voltage is applied to charge the battery assembly and the second AC voltage is provided to an external system via the outlet.

In addition to the one or more features described herein, the charging circuit includes a primary DC-DC converter connected to the common transformer.

In addition to the one or more features described herein, the common transformer is selectively connected to at least one of the battery assembly, and one or more low voltage components of the vehicle.

In addition to the one or more features described herein, the common transformer is selectively connected to the battery assembly by a high voltage DC-DC converter configured to provide a high voltage to the battery assembly, and the common transformer is selectively connected to the one or more low voltage components by a low voltage DC-DC converter.

In addition to the one or more features described herein, the split phase inverter includes a set of switches in a half bridge configuration.

In addition to the one or more features described herein, the outlet includes an integrated adapter configured to convert the second AC voltage to an output voltage that conforms to voltage requirements of the outlet.

In addition to the one or more features described herein, the integrated adapter is configured to convert between 120 Volts and 240 Volts.

In addition to the one or more features described herein, the power module operates in the charging mode by generating the first AC voltage having a first phase and the second AC voltage having a second phase, the first phase equal to the second phase, and supplying the first and second AC voltages to the battery assembly.

In another exemplary embodiment, a method of controlling charging and discharging of a battery assembly of a vehicle includes connecting an alternating current (AC) power source to a power module configured to be selectively connected to an outlet and the battery assembly, the power module including a charging circuit having a bidirectional AC-direct current (DC) converter, and a split phase inverter, the charging circuit and the split phase inverter connected to a common transformer. The method also includes providing AC power at an input voltage to the power module, and performing at least one of charging the battery assembly via the charging circuit and simultaneously charging the battery assembly and discharging power to an external system. The external system is connected to the outlet, and charging and discharging includes generating a split phase voltage by the power module, the split phase voltage including a first AC voltage and a second AC voltage, the first AC voltage being out of phase with the second AC voltage, where the first AC voltage is applied to charge the battery assembly and the second AC voltage is provided to the external system via the outlet.

In addition to the one or more features described herein, the charging circuit includes a primary DC-DC converter connected to the common transformer.

In addition to the one or more features described herein, the common transformer is selectively connected to at least one of the battery assembly, and one or more low voltage components of the vehicle.

In addition to the one or more features described herein, the method includes supplying power to the one or more low voltage components, wherein supplying the power includes connecting the power module to a low voltage DC-DC converter.

In addition to the one or more features described herein, the split phase inverter includes a set of switches in a half bridge configuration.

In addition to the one or more features described herein, the outlet includes an integrated adapter configured to convert the input voltage to an output voltage that conforms to voltage requirements of the outlet.

In addition to the one or more features described herein, the method includes supplying power to the outlet, wherein supplying the power includes connecting the outlet to the AC power source, and adjusting the input voltage by the integrated adapter.

In addition to the one or more features described herein, charging the battery assembly includes generating the first AC voltage having a first phase and the second AC voltage having a second phase, the first phase equal to the second phase, and supplying the first and second AC voltages to the battery assembly.

In yet another exemplary embodiment, a system of a vehicle includes a battery assembly and a charging and discharging system including a controller configured to perform a method. The method includes detecting connection of an alternating current (AC) power source to a power module configured to be selectively connected to an outlet and the battery assembly, the power module including a charging circuit having a bidirectional AC-direct current (DC) converter, and a split phase inverter, the charging circuit and the split phase inverter connected to a common transformer. The method also includes receiving AC power at an input voltage at the power module, and performing at least one of charging the battery assembly via the charging circuit, and simultaneously charging the battery assembly and discharging power to an external system. The external system is connected to the outlet, and simultaneously charging and discharging includes generating a split phase voltage by the power module, the split phase voltage including a first AC voltage and a second AC voltage, the first AC voltage being out of phase with the second AC voltage, where the first AC voltage is applied to charge the battery assembly and the second AC voltage is provided to the external system via the outlet.

In addition to the one or more features described herein, the charging circuit includes a primary DC-DC converter connected to the common transformer, the common transformer selectively connected to at least one of the battery assembly, and one or more low voltage components of the vehicle.

In addition to the one or more features described herein, the outlet includes an integrated adapter configured to convert the input voltage to an output voltage that conforms to voltage requirements of the outlet.

In addition to the one or more features described herein, charging the battery assembly includes generating the first AC voltage having a first phase and the second AC voltage having a second phase, the first phase equal to the second phase and supplying the first and second AC voltages to the battery assembly.

The above features and advantages, and other features and advantages of the disclosure are readily apparent from the following detailed description when taken in connection with the accompanying drawings.

### BRIEF DESCRIPTION OF THE DRAWINGS

Other features, advantages, and details appear, by way of example only, in the following detailed description, the detailed description referring to the drawings in which:

FIG. 1 is a schematic diagram of an electric or hybrid vehicle, in accordance with an exemplary embodiment;

FIG. 2 is a circuit diagram illustrating a power module configured to control aspects of charging and discharging, in accordance with an exemplary embodiment;

FIG. 3 depicts an example of a split phase AC voltage generated by the power module of FIG. 2;

FIG. 4 depicts an embodiment of a vehicle system, in accordance with an exemplary embodiment;

FIG. 5 depicts a conventional vehicle system including components for powering low voltage loads; and

FIG. 6 depicts a computer system for performing aspects of charging and discharging, in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

In accordance with exemplary embodiments, methods, devices and systems are provided for facilitating charging and discharging of battery assemblies and battery systems, such as vehicle battery assemblies. An embodiment of a battery charging system includes a power module having an alternating current (AC)-direct current (DC) converter and a split phase converter. The power module is controllable to generate a split phase voltage including two AC voltages, which may be in phase or out of phase. The power module may be used to control charging of a battery system (e.g., a vehicle battery pack) and to supply power to external loads (e.g., AC loads).

The power module may also be used to simultaneously charge the battery system while supplying power to one or more external loads. In an embodiment, the power module is configured to split an input voltage (e.g., from an electrical grid or AC charger) into separate AC voltages that are out of phase (e.g., separated by 180 degrees). One of the voltages is provided to the battery system for charging thereof, and another of the voltages is provided to an external load via one or more outlets. Each outlet may include an integrated adapter for providing different voltage levels (e.g., 120 and 240 Volts).

Embodiments described herein present numerous advantages and technical effects. The embodiments provide discharging and charging capability, including simultaneous charging and discharging (e.g., charging a battery system while supplying power to a grid or external device or system) without the need for additional circuitry. The functionality described herein is thus achievable with fewer components than conventional systems.

For example, an on board charger having the capabilities described herein can be provided, which can produce split phase voltage and perform simultaneous charging and discharging without a reduction in charging power and without any additional circuitry (as compared to existing onboard charging modules (OBCMs)). Embodiments provide for a single module or device that can provide vehicle charging and split phase power (as compared to existing systems that utilize a separate OBCM module and split phase power module).

Split phase voltage is achieved partly though AC-DC conversion circuitry, and partly through a split phase inverter stage, which can be used to provide additional charge power when split phase loads are not connected. Power modules described herein may be used for vehicle to grid and vehicle to home applications, and any other applications for supplying power to external AC loads, without the need for a separate module for providing split phase power.

The embodiments are not limited to use with any specific vehicle or device or system that utilizes battery assemblies, and may be applicable to various contexts. For example, embodiments may be used with automobiles, trucks, aircraft, construction equipment, farm equipment, automated factory equipment and/or any other device or system that may use high voltage battery packs or other battery assemblies.

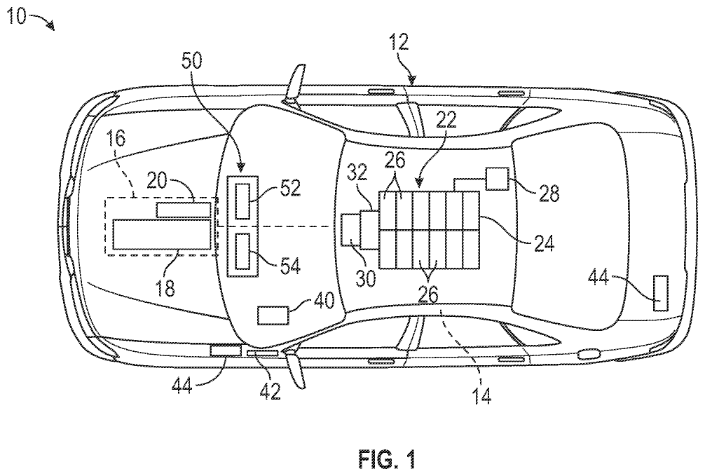

FIG. 1 shows an embodiment of a motor vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, a fuel injection subsystem, an exhaust subsystem and others.

The vehicle 10 may be a combustion engine vehicle, an electrically powered vehicle (EV) or a hybrid vehicle. In an embodiment, the vehicle 10 is a hybrid vehicle that includes a combustion engine system 18 and at least one electric motor assembly. In an embodiment, the propulsion system 16 includes an electric motor 20, and may include one or more additional motors positioned at various locations. The vehicle 10 may be a fully electric vehicle having one or more electric motors.

The vehicle 10 includes a battery system 22, which may be electrically connected to the motor 20 and/or other components, such as vehicle electronics. The battery system 22 may be configured as a rechargeable energy storage system (RESS). In an embodiment, the battery system 22 includes a battery assembly such as a high voltage battery pack 24 having a plurality of battery modules 26. The battery system 22 may also include a monitoring unit 28 that includes components such as a processor, memory, an interface, a bus and/or other suitable components.

Each battery module includes a plurality of cells (not shown) having a selected chemistry. In an embodiment, each cell is a lithium-ion battery, such as a lithium ferro-phosphate (LFP) battery or lithium nickel manganese colbalt oxide (NCM) battery. The battery pack 24 is not so limited and can have any suitable chemistry. Other examples include nickel-metal hydride and lead acid chemistries.

The battery system 22 is electrically connected to components of the propulsion system 16. The propulsion system also includes an inverter module 30 and a DC-DC converter module 32. The inverter module 30 (e.g., a traction power inverter unit or TPIM) converts direct current (DC) power from the battery system 22 to poly-phase alternating current (AC) power (e.g., three-phase, six-phase, etc.) to drive the motor 20.

Various control modules (electronic control modules or ECUs) may be included in the vehicle 10. In an embodiment, the vehicle 10 includes an integrated power module 40 that is configured to control aspects of charging the battery pack 24, and discharging the battery pack to supply power to an external system, such as a power grid. The power module 40 is selectively connected to a bi-directional charge port 42 and one or more electrical outlets 44. It is noted that embodiments are not limited to the number or location of outlets shown, as there may be any number of outlets at desired locations throughout the vehicle.

The vehicle 10 also includes a computer system 50 that includes one or more processing devices 52 and a user interface 54. The various processing devices and units may communicate with one another via a communication device or system, such as a controller area network (CAN) or transmission control protocol (TCP) bus.

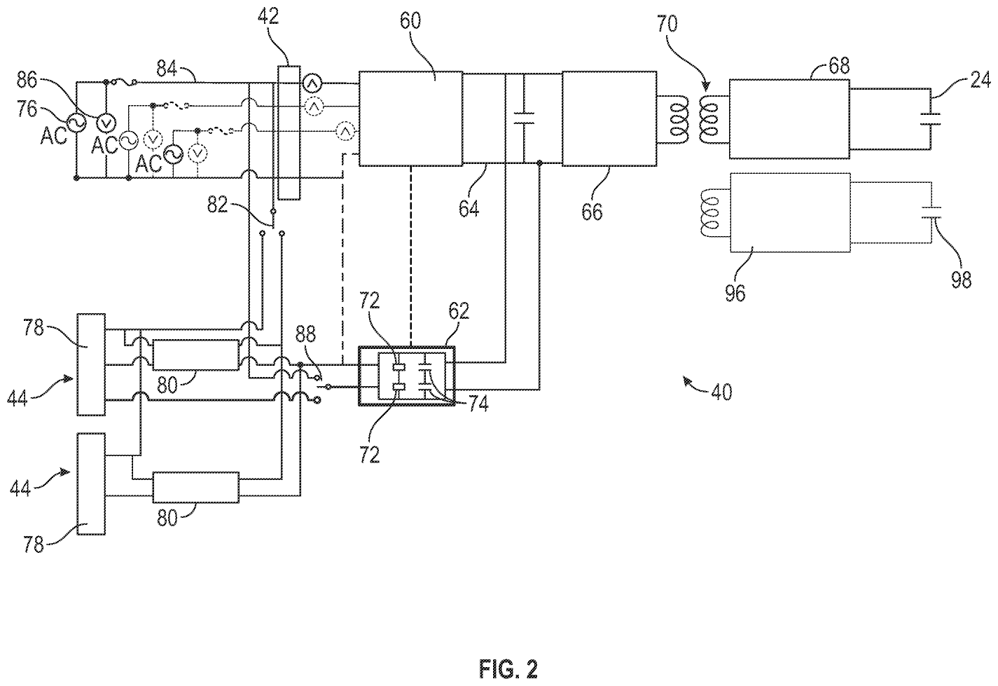

FIG. 2 depicts an embodiment of the power module 40, as well as connections between the power module 40 and other components of the vehicle 10. As shown, the power module 40 includes a bi-directional AC-DC converter 60 having power factor correction (PFC) functionality, and an inverter 62 (also referred to as a split phase inverter) connected to a DC bus 64.

The DC bus 64 is connected to a primary DC-DC converter 66 (primary stage). The primary DC-DC converter 66 is connected to a secondary DC-DC converter 68 (secondary stage) and the battery pack 24 via a transformer 70.

The inverter 62, in an embodiment, is a half bridge converter stage that operates in cooperation with the AC-DC converter 60 to generate a split voltage in the form of two independent AC voltages. The two voltages may be in phase (e.g., when exclusively charging the battery pack 24) or out of phase (e.g., when simultaneously charging the battery pack 24 and supplying power to an external load). For example, as shown in FIG. 2, the inverter 62 includes a pair of switches 72 in a half bridge, and a set of capacitors 74.

When the charge port 42 or an outlet 44 is connected to an AC power source (represented by phase currents 76), such as a grid or generator, the power module 40 may be used to charge the battery pack 24 and/or provide power to one or more external loads. As discussed herein, the power module 40 may be used exclusively to charge the battery pack 24 (e.g., functioning as an OBCM) by providing both voltages of a split phase voltage to the battery pack 24. The power module 40 may also be used to simultaneously charge the battery pack 24 and provide power to external loads, by providing one part of the split voltage to the battery pack 24 and another part of the split voltage to one or more external loads.

FIG. 2 also depicts an embodiment of one or more power outlets 44, which may be used to facilitate receiving AC power or supplying AC power. In this embodiment, each outlet 44 includes a connection port 78 integrated with an adapter 80. The adapter 80 is provided to convert an input or output voltage to conform to the voltage of an AC power or voltage requirements of an external load.

For example, each adapter 80 is configured to convert between 240 Volts (V) and 120 V, and a dedicated adapter 80 is provided for each outlet 44. This distributed configuration greatly reduces the size of 240V/120V conversion components as compared to existing systems.

The adapters 80 may be powered from any suitable source, such as the battery pack 24, a low voltage battery, or an external power source. For example, each adapter 80 is connected to one or more switches, such as a relay 82, which can be controlled to selectively provide power to the outlets 44. The power module 40 includes or is connected to one or more other switching devices, such as a relay 88 for selectively connecting the inverter 62 to the outlets 44.

For example, if the input voltage from the power source (current(s) 76) conforms to power requirements of the outlets (e.g., 120 V), the input voltage is directly connected to the outlets 44. If the input voltage does not conform (e.g., the input voltage is 240 V), each adapter 80 is used as needed to step down or otherwise adjust the input voltage. A voltage sensor 86 may be included for determining whether voltage adjustment is desired.

The power module 40 is controllable by any suitable processing device or processing system, referred to as a controller 84. The controller may be a pre-existing controller or a dedicated controller.

The power module 40 is controlled to operate according to one or more of a plurality of operating modes. The operating modes may include a charging mode, a discharging mode, and a simultaneous charging and discharging mode.

The following is a description of the various operating modes and corresponding method(s) for controlling power transfer. The operating modes include a charging mode for providing charge to the battery pack 24, and a discharging mode for supplying power from the battery pack 24 to other components or loads, including external loads (e.g., an electrical grid or residential loads).

The operating modes also include a simultaneous charging and discharging mode, in which the power module 40 is operated to provide a split phase voltage that is used to charge the battery pack 24 while simultaneously providing power to an external load or loads.

In these modes, the relay 88 is closed to connect the inverter 62 to the load 76 and the outlets 44. The input voltage (e.g., grid voltage of 120 V or 240 V) generates one part of the AC voltage required for split phase, and the inverter 62 generates the other part of AC voltage.

In the charging mode, the relay 82 is open, and both parts of the split phase voltage are provided to the battery pack 24 for charging. Both parts are in phase.

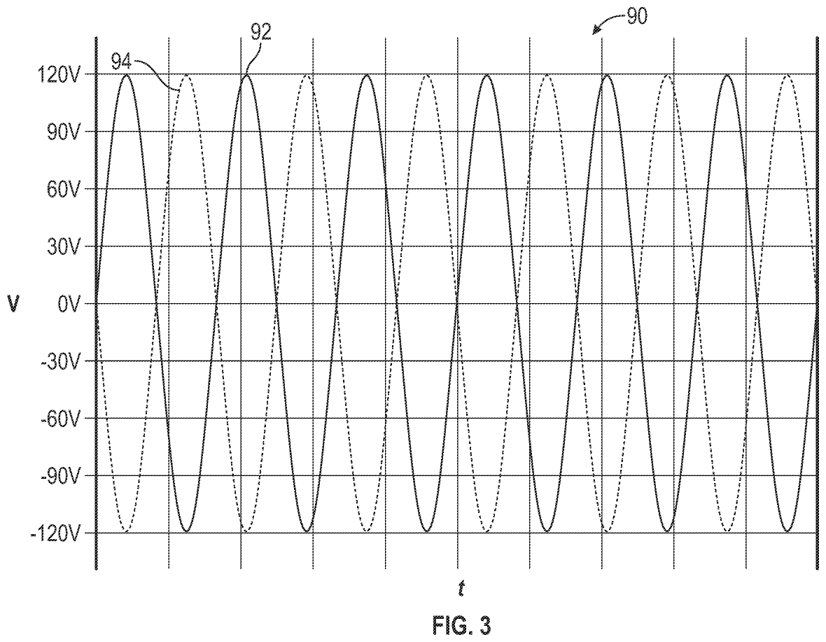

In the simultaneous charging and discharging mode, the inverter 62 phase shifts one of the parts of the split phase voltage. An example of the split phase voltage is shown in FIG. 3, which includes a graph 90 of voltage V as a function of time t. In this example, the grid voltage is 120 V, and the power module 40 generates a first AC voltage 92 from the grid voltage, and the inverter 62 generates a second AC voltage 94 that is separated by 180 degrees from the first AC voltage 92.

Embodiments may be used to charge a high voltage battery system such as the battery pack 24, and/or to charge low voltage devices. A “high voltage” refers to a voltage sufficient to power the battery pack, which may be 400 V, 800 V or any other suitable voltage. “Low voltage” refers to a voltage sufficient to power other components having an operating voltage lower than the high voltage. For example, a low voltage may be 12 V, 24 V or other suitable voltage for powering components such as electronics in the vehicle 10. Low and high are used as relative terms and are not intended to denote any specific voltage level.

In an embodiment, the power module 40 may be used to control the supply of power to low voltage components. In this embodiment, the power module 40 performs functions related to supplying power to low voltage components. Thus, the power module 40 can replace existing modules such as an auxiliary power module (APM).

For example, as shown in FIG. 2, the vehicle 10 (FIG. 1) includes a low voltage DC-DC converter 96 configured to step down a received voltage to power low voltage loads 98. The power module 40 may be put into a charging mode in which part of the split phase voltage is provided to the DC-DC converter 96.

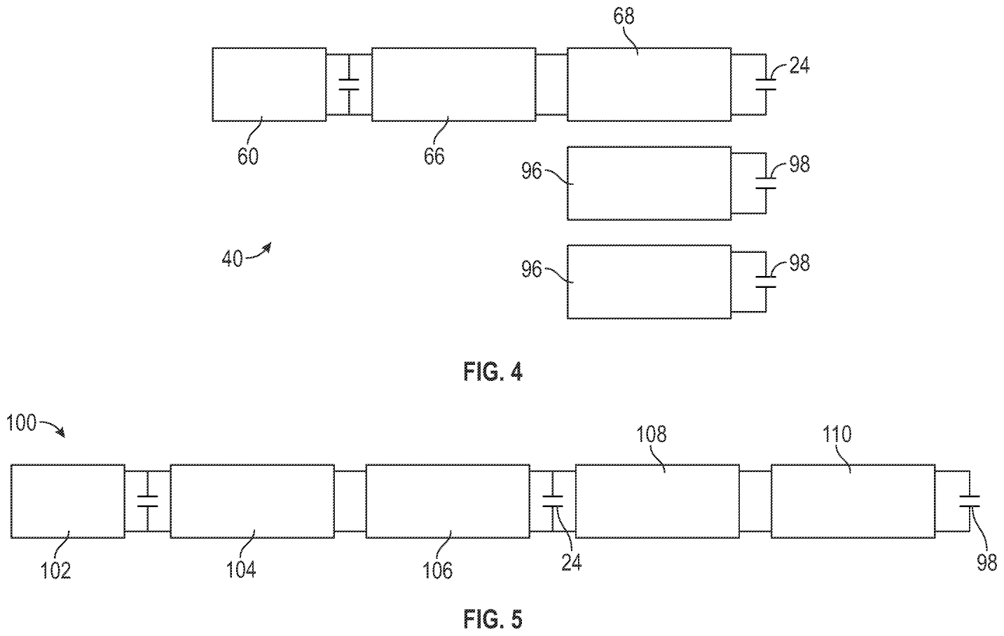

FIG. 4 shows an example of a configuration of the power module 40 and connections to the battery pack 24 and low voltage loads 98. As shown, charging the battery pack 24 and charging low voltage components can be accomplished using a single primary DC-DC stage (i.e., the DC-DC converter 66).

FIG. 5 shows an example of a configuration of a low voltage charging system 100 in a conventional electric or hybrid vehicle. The system 100 includes an AC-DC conversion stage 102, and a transformer (not shown) connecting a primary DC-DC stage 104 and a secondary DC-DC stage 106 to the battery pack 24. To power the low voltage components 98, a separate transformer connecting primary and secondary stages 108 and 110 is provided.

As is demonstrated by FIGS. 4 and 5, the power module 40 reduces the number of components needed to be able to charge both high voltage and low voltage components. The power module 40 uses a common transformer and thus only one primary stage that can be used for both high and low voltages.

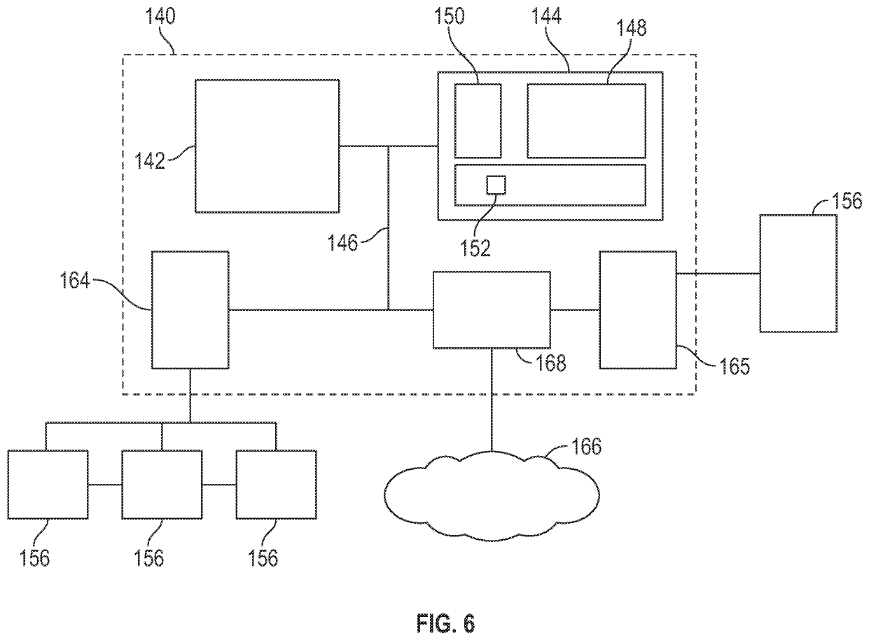

FIG. 6 illustrates aspects of an embodiment of a computer system 140 that can perform various aspects of embodiments described herein. The computer system 140 includes at least one processing device 142, which generally includes one or more processors for performing aspects of image acquisition and analysis methods described herein.

Components of the computer system 140 include the processing device 142 (such as one or more processors or processing units), a memory 144, and a bus 146 that couples various system components including the system memory 144 to the processing device 142. The system memory 144 may include a variety of computer system readable media. Such media can be any available media that is accessible by the processing device 142, and includes both volatile and non-volatile media, and removable and non-removable media.

For example, the system memory 144 includes a non-volatile memory 148 such as a hard drive, and may also include a volatile memory 150, such as random access memory (RAM) and/or cache memory. The computer system 140 can further include other removable/non-removable, volatile/non-volatile computer system storage media.

The system memory 144 can include at least one program product having a set (e.g., at least one) of program modules that are configured to carry out functions of the embodiments described herein. For example, the system memory 144 stores various program modules that generally carry out the functions and/or methodologies of embodiments described herein. A module or modules 152 may be included to perform functions related to monitoring and performing charging and discharging operations described herein. The system 140 is not so limited, as other modules may be included. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 142 can also communicate with one or more external devices 156 as a keyboard, a pointing device, and/or any devices (e.g., network card, modem, etc.) that enable the processing device 142 to communicate with one or more other computing devices. Communication with various devices can occur via Input/Output (I/O) interfaces 164 and 165.

The processing device 142 may also communicate with one or more networks 166 such as a local area network (LAN), a general wide area network (WAN), a bus network and/or a public network (e.g., the Internet) via a network adapter 168. It should be understood that although not shown, other hardware and/or software components may be used in conjunction with the computer system 40. Examples include, but are not limited to: microcode, device drivers, redundant processing units, external disk drive arrays, RAID systems, and data archival storage systems, etc.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system for controlling charging and discharging of a battery assembly of a vehicle, comprising:
an outlet;
a power module configured to be selectively connected to the outlet and the battery assembly, the power module including a charging circuit having a bidirectional alternating current (AC)-direct current (DC) converter and a split phase inverter, the charging circuit and the split phase inverter connected to a common transformer; and
a controller configured to control the power module according to at least one of a plurality of operating modes, the plurality of operating modes including:
a charging mode in which AC power from a power source charges the battery assembly via the charging circuit; and
a simultaneous charging and discharging mode in which the power module generates a split phase voltage including a first AC voltage and a second AC voltage, the first AC voltage being out of phase with the second AC voltage, wherein the first AC voltage is applied to charge the battery assembly and the second AC voltage is provided to an external system via the outlet.

2. The system of claim 1, wherein the charging circuit includes a primary DC-DC converter connected to the common transformer.

3. The system of claim 2, wherein the common transformer is selectively connected to at least one of the battery assembly, and one or more low voltage components of the vehicle.

4. The system of claim 3, wherein the common transformer is selectively connected to the battery assembly by a high voltage DC-DC converter configured to provide a high voltage to the battery assembly, and the common transformer is selectively connected to the one or more low voltage components by a low voltage DC-DC converter.

5. The system of claim 1, wherein the split phase inverter includes a set of switches in a half bridge configuration.

6. The system of claim 1, wherein the outlet includes an integrated adapter configured to convert the second AC voltage to an output voltage that conforms to voltage requirements of the outlet.

7. The system of claim 6, wherein the integrated adapter is configured to convert between 120 Volts and 240 Volts.

8. The system of claim 1, wherein the power module operates in the charging mode by generating the first AC voltage having a first phase and the second AC voltage having a second phase, the first phase equal to the second phase, and supplying the first and second AC voltages to the battery assembly.

9. A method of controlling charging and discharging of a battery assembly of a vehicle, comprising:
connecting an alternating current (AC) power source to a power module configured to be selectively connected to an outlet and the battery assembly, the power module including a charging circuit having a bidirectional AC-direct current (DC) converter, and a split phase inverter, the charging circuit and the split phase inverter connected to a common transformer;
providing AC power at an input voltage to the power module; and
performing at least one of:
charging the battery assembly via the charging circuit; and
simultaneously charging the battery assembly and discharging power to an external system, the external system connected to the outlet, wherein simultaneously charging and discharging includes generating a split phase voltage by the power module, the split phase voltage including a first AC voltage and a second AC voltage, the first AC voltage being out of phase with the second AC voltage, wherein the first AC voltage is applied to charge the battery assembly and the second AC voltage is provided to the external system via the outlet.

10. The method of claim 9, wherein the charging circuit includes a primary DC-DC converter connected to the common transformer.

11. The method of claim 10, wherein the common transformer is selectively connected to at least one of the battery assembly, and one or more low voltage components of the vehicle.

12. The method of claim 11, further comprising supplying power to the one or more low voltage components, wherein supplying the power includes connecting the power module to a low voltage DC-DC converter.

13. The method of claim 9, wherein the split phase inverter includes a set of switches in a half bridge configuration.

14. The method of claim 9, wherein the outlet includes an integrated adapter configured to convert the input voltage to an output voltage that conforms to voltage requirements of the outlet.

15. The method of claim 14, further comprising supplying power to the outlet, wherein supplying the power includes connecting the outlet to the AC power source, and adjusting the input voltage by the integrated adapter.

16. The method of claim 9, wherein charging the battery assembly includes generating the first AC voltage having a first phase and the second AC voltage having a second phase, the first phase equal to the second phase, and supplying the first and second AC voltages to the battery assembly.

17. A system of a vehicle, comprising:
a battery assembly;
a charging and discharging system including a controller configured to perform a method comprising:
detecting connection of an alternating current (AC) power source to a power module configured to be selectively connected to an outlet and the battery assembly, the power module including a charging circuit having a bidirectional AC-direct current (DC) converter, and a split phase inverter, the charging circuit and the split phase inverter connected to a common transformer;
receiving AC power at an input voltage at the power module; and
performing at least one of:
charging the battery assembly via the charging circuit; and
simultaneously charging the battery assembly and discharging power to an external system, the external system connected to the outlet, wherein simultaneously charging and discharging includes generating a split phase voltage by the power module, the split phase voltage including a first AC voltage and a second AC voltage, the first AC voltage being out of phase with the second AC voltage, wherein the first AC voltage is applied to charge the battery assembly and the second AC voltage is provided to the external system via the outlet.

18. The system of claim 17, wherein the charging circuit includes a primary DC-DC converter connected to the common transformer, the common transformer selectively connected to at least one of the battery assembly, and one or more low voltage components of the vehicle.

19. The system of claim 17, wherein the outlet includes an integrated adapter configured to convert the input voltage to an output voltage that conforms to voltage requirements of the outlet.

20. The system of claim 17, wherein charging the battery assembly includes generating the first AC voltage having a first phase and the second AC voltage having a second phase, the first phase equal to the second phase and supplying the first and second AC voltages to the battery assembly.
